(19) United States
(12) Patent Application Publication
(10) Pub. No.: US 2018/0257592 A1
(43) Pub. Date: Sep. 13, 2018

(54) BUMPER INTEGRATED CARGO CARRIER FOR A MOTOR VEHICLE

(71) Applicant: FORD GLOBAL TECHNOLOGIES, LLC, Dearborn, MI (US)

(72) Inventor: Jorge Adolfo Miranda Nieto, Leon (MX)

(21) Appl. No.: 15/455,209

(22) Filed: Mar. 10, 2017

(51) Int. Cl. B60R 19/48

(52) U.S. Cl. CPC B60R 19/48; B60R 9/10

(57) ABSTRACT

A bumper integrated cargo carrier includes a bumper assembly, a first pivot arm and a second pivot arm. Each of the pivot arms includes a plurality of loops and a plurality of channels for connecting and holding various cargo carriers between the pivot arms.

### TECHNICAL FIELD

This document relates generally to the motor vehicle equipment field and, more particularly, to a bumper integrated cargo carrier that may be stowed and maintained with the motor vehicle at all times and includes pivot arms that may be quickly and easily deployed for use at the discretion of the motor vehicle operator. A related method of carrying cargo is also provided.

### BACKGROUND

Many motor vehicle operators desire additional storage capacity that may be utilized without compromising interior space as well as versatile cargo handling capability to meet the needs of different cargo applications.

This document relates to a new and improved cargo carrier that is integrated into the bumper of the motor vehicle. Advantageously, that bumper integrated cargo carrier may be stowed on the motor vehicle when not in use, hidden from view while maintaining an aesthetically pleasing appearance. When needed, pivot arms of the integrated cargo carrier may be quickly and easily deployed in a simple and efficient manner while also being configurable to meet the needs of any particular cargo application. As such, the bumper integrated cargo carrier represents a significant advance in the art.

### SUMMARY

In accordance with the purposes and benefits described herein, a bumper integrated cargo carrier is provided. That bumper integrated cargo carrier comprises a bumper assembly, a first pivot arm and a second pivot arm. The bumper assembly includes a first receiver and a second receiver. The first pivot arm is displaceable between a first stowed position in the first receiver and a first deployed position projecting from the first receiver. The second pivot arm is displaceable between a second stowed position in the second receiver and a second deployed position projecting for the second receiver.

A first pivot pin may connect the first pivot arm to the bumper assembly. Similarly, a second pivot pin may connect the second pivot arm to the bumper assembly. The bumper assembly may also include an outer face with the first pivot and the second pivot inboard the outer face of the bumper assembly where they are out of sight and at least somewhat protected from inclement weather conditions.

The first pivot arm may include a first face contoured to follow and be flush with the outer face when the first pivot arm is in the first stowed position in the first receiver. Similarly, the second pivot arm may include a second face contoured to follow and be flush with the outer face when the second pivot arm is in the second stowed position in the second receiver.

The first pivot arm may include a first set of loops. The first pivot arm may also include a first set of channels. The loops of the first set of loops may alternate with the channels of the first set of channels along a given length of the bumper arm.

Similarly, the second pivot arm may include a second set of loops and a second set of channels. Loops of the second set of loops may alternate with channels of the second set of channels along a given length of the second pivot arm.

The bumper integrated cargo carrier may also include a cargo net. That cargo net may be stretched between and connected to the first set of loops on the first pivot arm and the second set of loops on the second pivot arm so as to provide a space for carrying cargo between the pivot arms.

The bumper integrated cargo carrier may also include a set of cargo bars. Those cargo bars may be utilized to extend between the first set of channels on the first pivot arm and the second set of channels on the second pivot arm so as to provide a space for carrying cargo. Each cargo bar may also include an elongated channel. When the cargo bars are positioned in the two pivot arms so that the elongated channels open upward, the channels may form convenient cavities for holding the wheel of a bicycle or other structure of the cargo to be carried by the bumper integrated cargo carrier.

When not in use, the cargo net and the set of cargo bars may be conveniently stored in a compartment underneath the cargo floor of the cargo compartment of the motor vehicle.

In accordance with an additional aspect, a pivot arm is provided for a cargo carrier. That pivot arm comprises an elongated body, a first set of loops carried on the elongated body and a first set of channels carried on the elongated body. In one of many possible embodiments, the loops of the first set of loops may alternate with the channels of the first set of channels along a given length of the elongated body. In addition, the pivot arm may include a receiver and a pivot pin secured in the receiver. That pivot provides a pivot point for displacing the pivot arm between stowed and deployed positions.

In accordance with still another aspect, a method is provided for carrying cargo. That method comprises the steps of pivoting a first pivot arm from a first stowed position into a first deployed position, pivoting a second pivot arm from a second stowed position into a second deployed position and securing an article carrier between the first pivot arm and the second pivot arm. In one of many possible embodiments the method further includes the step of connecting a cargo net between a first set of loops provided on the first pivot arm and a second set of loops provided on the second pivot arm. In another of many possible embodiments, the method includes the step of connecting cargo bars between a first set of channels provided on the first pivot arm and a second set of channels provided on the second pivot arm.

In the following description, there are shown and described several preferred embodiments of the bumper integrated cargo carrier, the pivot arm for a cargo carrier and the method for carrying cargo. As it should be realized, the cargo carrier, the pivot arm and the method are capable of other, different embodiments and their several details are capable of modification in various, obvious aspects all without departing from the cargo carrier, pivot arm and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the bumper integrated cargo carrier and pivot arm for a cargo carrier and together with the description serve to explain certain principles thereof.

FIG. 1 is a rear perspective view of a motor vehicle equipped with the bumper integrated cargo carrier which is illustrated in the stowed position.

FIG. 2 is a view similar to FIG. 1 but showing the bumper integrated cargo carrier with the first pivot arm and the second pivot arm in the deployed position.

FIG. 3 is a schematic plan view of the first pivot arm illustrated in phantom line in the stowed position and in full line in the deployed position.

FIG. 4 is a schematic plan view of the second pivot arm illustrated in phantom line in the stowed position and in full line in the deployed position.

FIG. 5 is a detailed perspective view illustrating the alternating loops and channels on the first pivot arm.

FIG. 6 is a detailed perspective view illustrating the alternating loops and channels on the second pivot arm.

FIG. 7 is a perspective view illustrating a cargo net stretched between the loops of the first and second pivot arms.

FIG. 8 is a perspective view illustrating a set of cargo bars extending between the channels on the first and second pivot arms.

FIG. 8a is a perspective view illustrating how a bicycle may be carried on the cargo bars of the bumper integrated cargo carrier.

FIG. 9 is a perspective view illustrating how the set of cargo bars may be stored in the motor vehicle when not in use.

Reference will now be made in detail to the present preferred embodiments of the bumper integrated cargo carrier and the pivot arm for a cargo carrier, examples of which are illustrated in the accompanying drawing figures.

### DETAILED DESCRIPTION

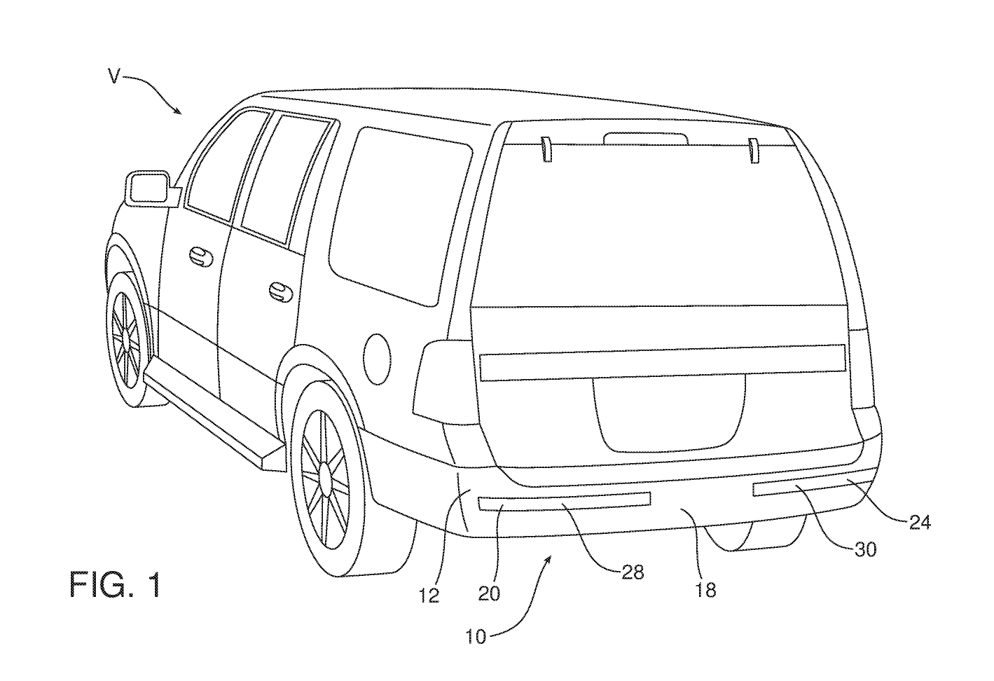

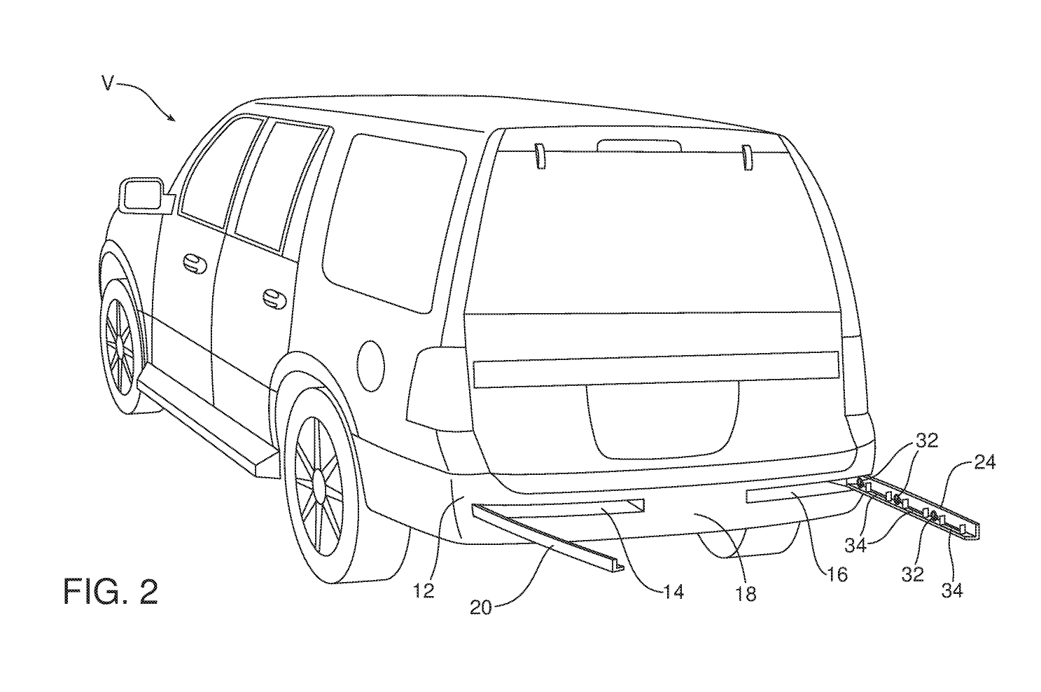

Reference is now made to FIGS. 1 and 2 illustrating a motor vehicle V including the bumper integrated cargo carrier 10. In the illustrated embodiment, the bumper integrated cargo carrier 10 includes a bumper assembly 12 including a first receiver 14, a second receiver 16 and an outer face 18 forming a portion of the cosmetic outer surface of the motor vehicle V.

As illustrated in FIGS. 1-4, a first pivot arm 20 is pivotally connected to the bumper assembly 12 by means of a first pivot 22. Similarly, a second pivot arm 24 is pivotally connected to the bumper assembly 12 by means of a second pivot 26. As should be appreciated, the first pivot 22 and the second pivot 26 are inboard the outer face 18 of the bumper assembly 12 where they are hidden from view and at least partially protected from inclement weather conditions.

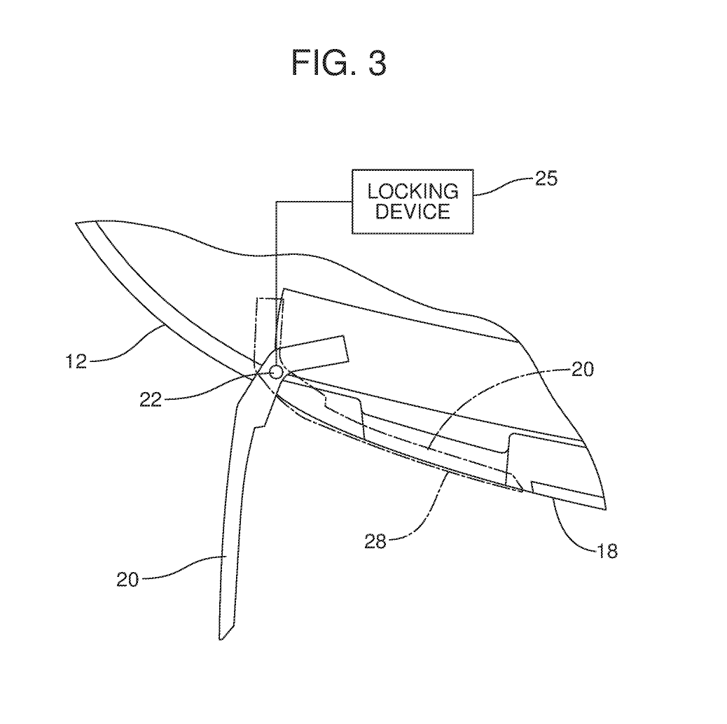

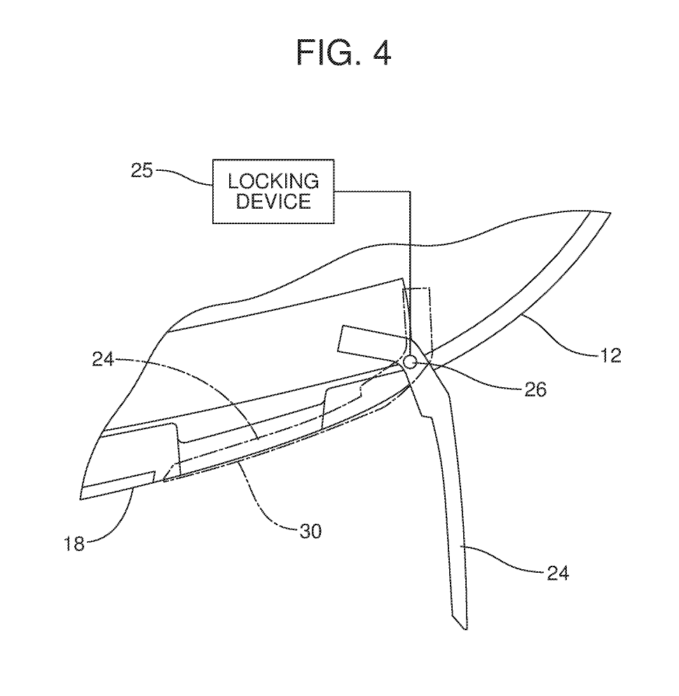

The first pivot arm 20 is displaceable between a first stowed position in the first receiver 14 (see particularly FIG. 1 and phantom line depiction in FIG. 3) and a first deployed position projecting rearwardly from the first receiver (see FIG. 2 and full line depiction in FIG. 3). Similarly, the second pivot arm 24 is displaceable between a second stowed position in the second receiver 16 (see FIG. 1 and phantom line depiction in FIG. 4) and a second deployed position projecting rearwardly from the second receiver (see FIG. 2 and full line depiction in FIG. 4). Locking devices 25 known in the art may be utilized to secure the first pivot arm in the first stowed and first deployed positions and the second pivot arm 24 in the second stowed and second deployed positions. Such locking devices 25 include but are not necessarily limited to fixed mechanisms such as tabs or retainers, manual mechanisms such as locking pins or even a motor to position each pivot arm as desired.

As should best be appreciated from viewing FIG. 1, the first pivot arm 20 includes a first face 28 contoured to follow and be flush with the outer face 18 of the bumper assembly 12 when the first pivot arm is in the first stowed position in the first receiver 14. Similarly, the second pivot arm 24 includes a second face 30 that is contoured to follow and be flush with the outer face 18 of the bumper assembly 12 when the second pivot arm is in the second stowed position in the second receiver 16. Thus, it should be appreciated that the two pivot arms 20, 24 are effectively integrated into the outer face 18 of the bumper assembly 12 when stowed and provide an aesthetically pleasing appearance that does not otherwise interrupt the styling of the motor vehicle.

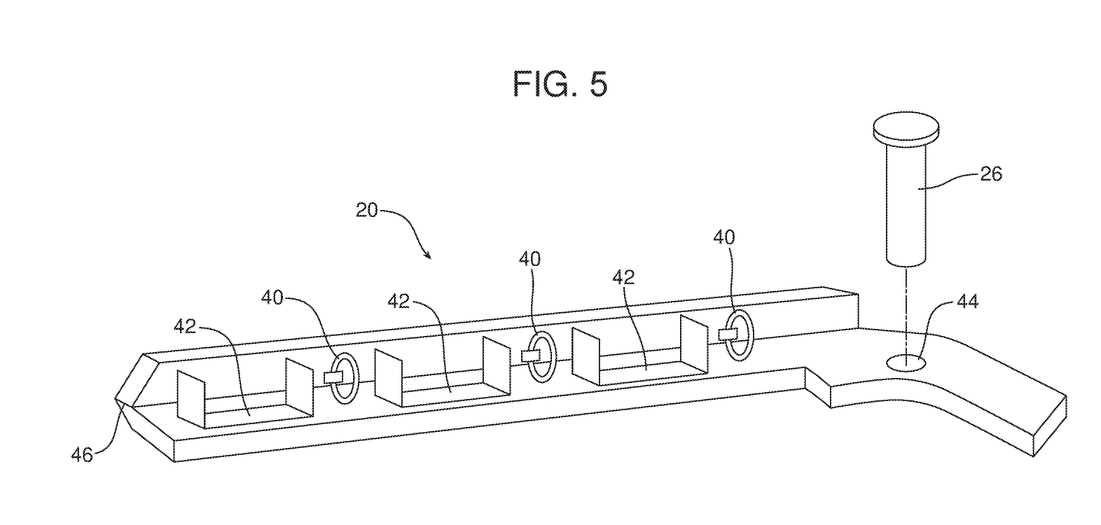

As best illustrated in FIG. 5, the first pivot arm 20 includes a first set of loops, rings or loops 32 and a first set of channels 34. In the illustrated embodiment, three loops 32 and three channels 34 are illustrated. Those loops 32 and channels 34 alternate along a given or predetermined length of the first pivot arm 20 extending from the pivot pin receiver 36 to the distal end 38 of the first pivot arm.

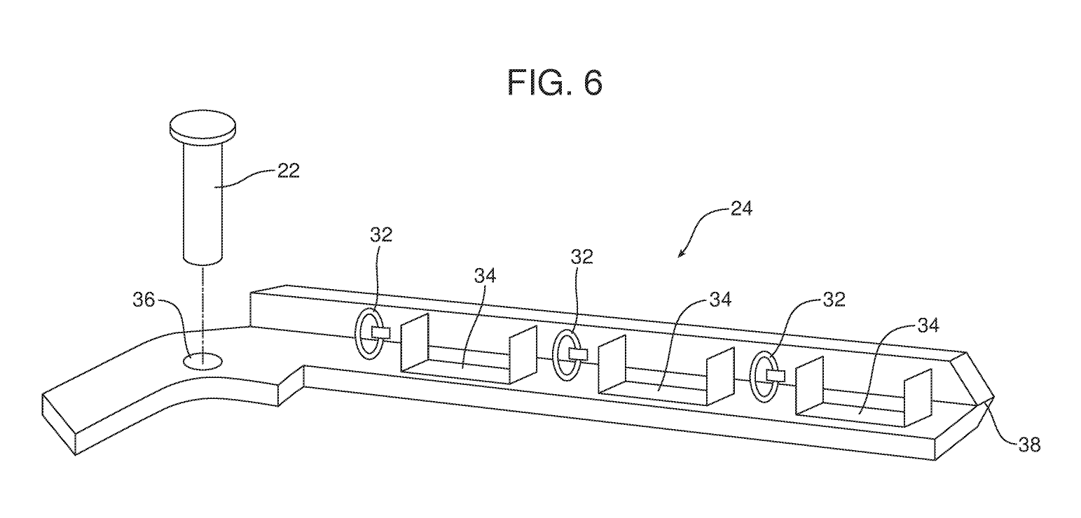

As illustrated in FIG. 6, the second pivot arm 24 includes a second set of loops 40 and a second set of channels 42. In the illustrated embodiment three loops 40 and three channels 42 are shown. The loops 40 and channels 42 alternate along a given or predetermined length of the second pivot arm 24 extending between the second pivot pin receiver 44 and the second distal end 46 of the second pivot arm.

When the first pivot arm 20 is in the first deployed position and the second pivot arm 24 is in the second deployed position as illustrated in FIG. 2, the pivot arms are in position to receive and hold a cargo carrier.

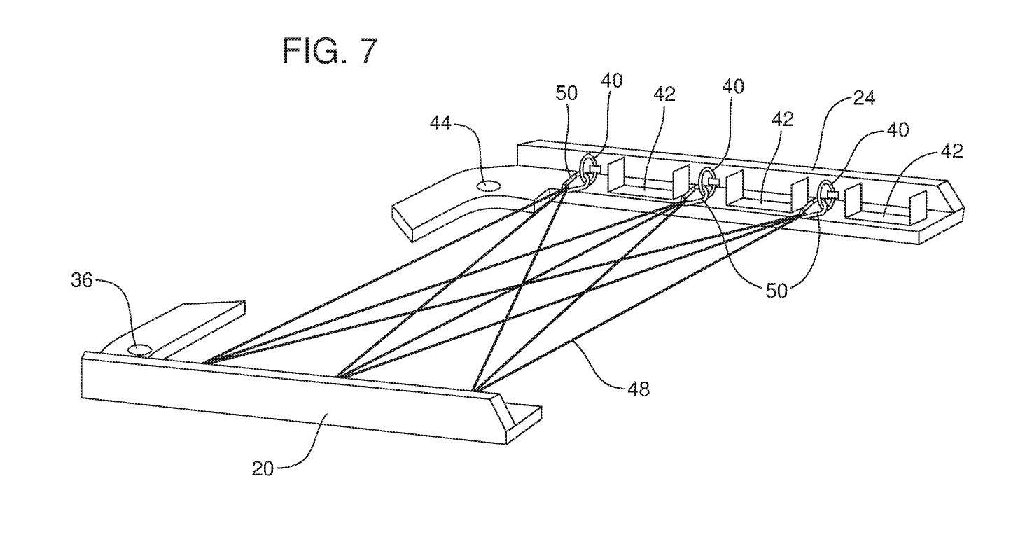

In one possible embodiment of the bumper integrated cargo carrier 10 illustrated in FIG. 7, the cargo carrier is a cargo net 48. The cargo net 48 may be made from an elastic material and include multiple carabiners 50 to connect the cargo net to each of the loops 32 on the first pivot arm 20 and the loops 40 on the second pivot arm 24. When secured as illustrated in FIG. 7, the cargo net 48 stretches between the first pivot arm 20 and the second pivot arm 24 providing an open air cargo carrier for holding cargo such as wet shoes, clothes, bags or other items suitable for carrying in a cargo net.

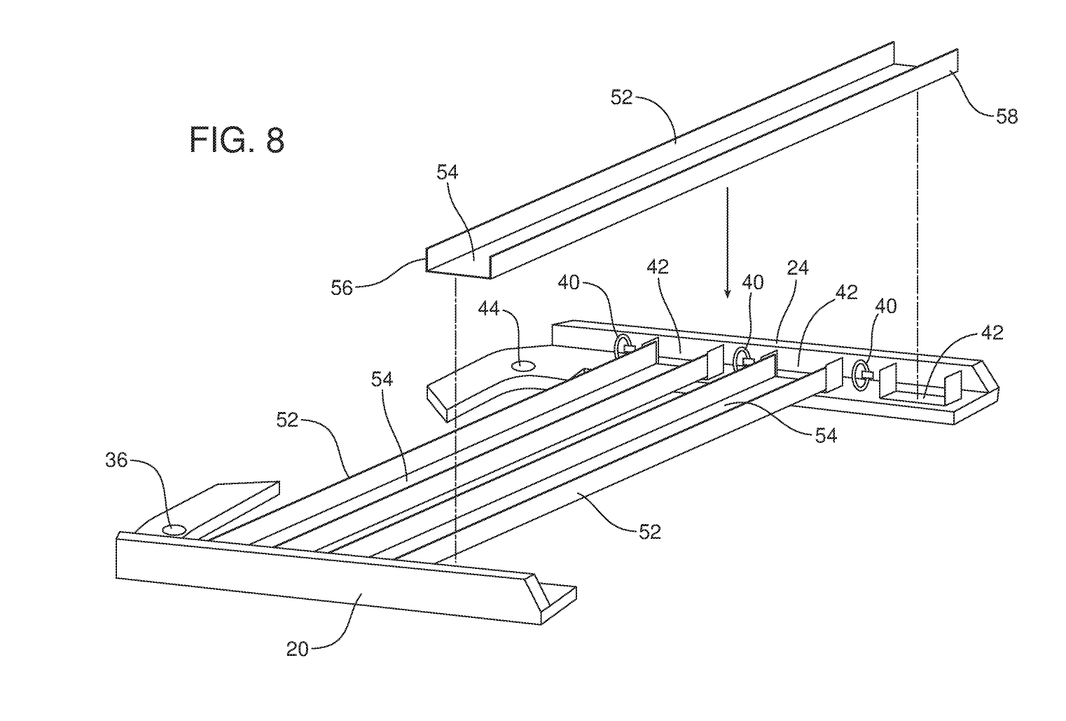

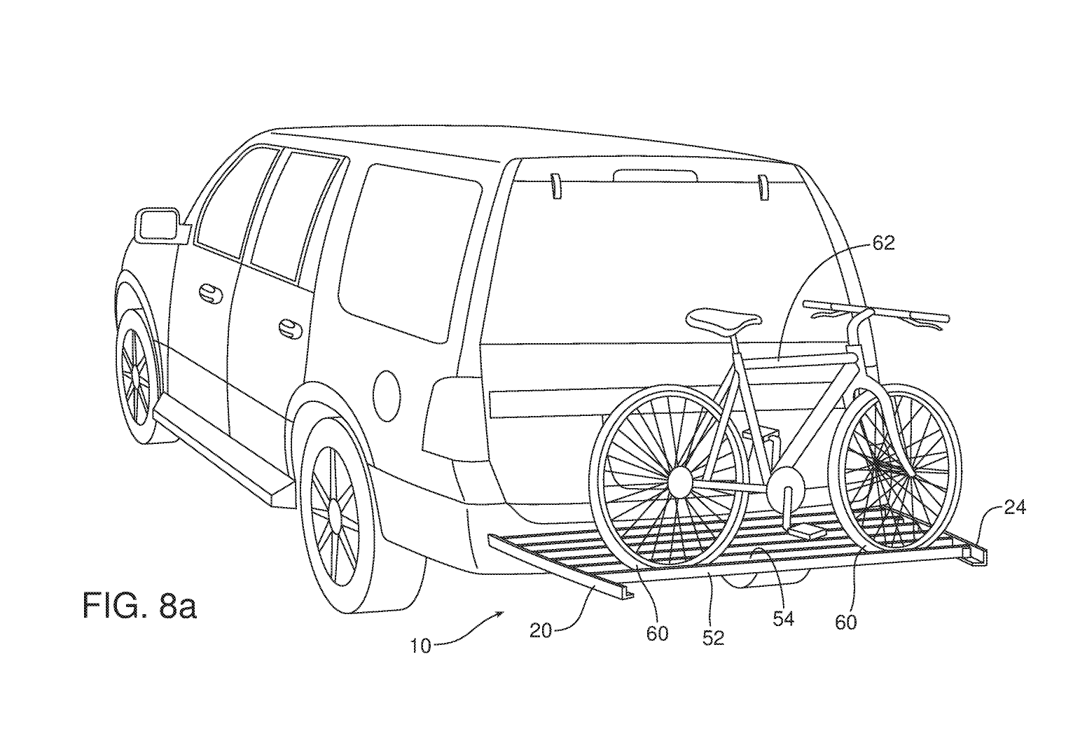

In another possible embodiment illustrated in FIG. 8, the cargo carrier comprises a set of cargo bars 52. Each of the cargo bars 52 may include an elongated channel 54. A first end 56 of each cargo bar 52 may be inserted in one of the channels 34 in the first pivot arm 20 while the second end 58 of each of the cargo bars may be inserted in the opposed channels 42 of the second pivot arm 24 so that the cargo bars are connected to and extend between the first pivot arm and the second pivot arm forming a cargo carrier platform. As illustrated in FIG. 8a, when the channels 54 are oriented to open upward, the channels 54 form a pocket for receiving and holding cargo in position such as the wheels 60 of the bicycles 62. Bungee cords and straps (not shown) may be utilized to complete the connection of the bicycles 62 on the cargo bars 52 of the bumper integrated cargo carrier 10.

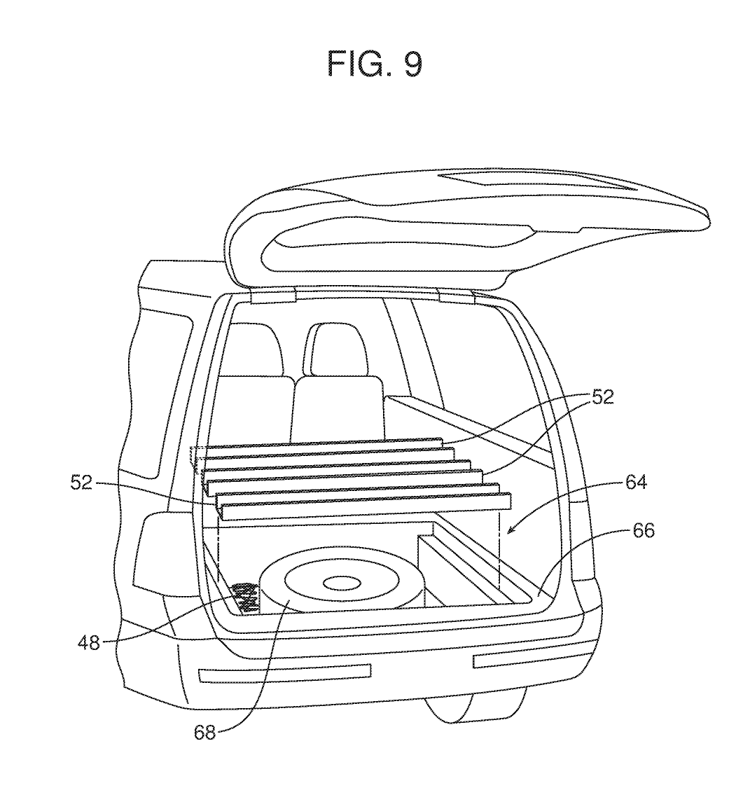

When the bumper integrated cargo carrier 10 is not in use, the cargo net 48 and the cargo bars 52 are disconnected from the first pivot arm 20 and second pivot arm 24. The cargo net 48 and the cargo bars 52 may be stowed in a storage compartment 64 under the storage compartment floor 66 over the spare wheel 68 in the interior of the motor vehicle. See FIG. 9. In addition, the locking device 25 may be released and the first pivot arm 20 may be displaced from the first deployed position to the first stowed position while the second pivot arm 24 may be displaced from the second deployed position to the second stowed position. When stowed, the first pivot arm 20 and second pivot arm 24 are effectively integrated into the bumper assembly 12 in the respective first receiver 14 and second receiver 16. More specifically, the first face 28 of the first pivot arm 20 and the second face 30 of the second pivot arm 24 blend into the outer face 18 of the bumper assembly 12 effectively concealing the bumper integrated cargo carrier.

Consistent with the above description, a method is provided for carrying cargo. That method includes the steps of: (a) pivoting a first pivot arm 20 from a first stowed position into a first deployed position, (b) pivoting a second pivot arm 24 from a second stowed position into a second deployed position and (c) securing an article carrier between the first pivot arm and the second pivot arm. The method may further include the step of connecting a cargo net 48 between a first set of loops 32 on the first pivot arm 20 and a second set of loops 40 on the second pivot arm 24. The method may also include the step of connecting cargo bars 52 between a first set of channels 34 on the first pivot arm 20 and a second set of channels 42 on the second pivot arm 24.

The foregoing has been presented for purposes of illustration and description. It is not intended to be exhaustive or to limit the embodiments to the precise form disclosed. Obvious modifications and variations are possible in light of the above teachings. For example, the first pivot arm 20 and second pivot arm 24 of the illustrated embodiment both include three loops 32 or 40 and three channels 34 or 42. A different number of loops 32, 40 and channels 34, 42 may be provided if desired. They also do not need to be provided in an alternating pattern. Further, the loops 32, 40 may assume a different shape or configuration so long as a cargo net or other appropriate cargo carrier may be connected thereto. Further it should be appreciated that the cargo carrier may assume other forms than the cargo net 48 illustrated in FIG. 7 and the cargo bars 52 illustrated in FIGS. 8 and 8a. All such modifications and variations are within the scope of the appended claims when interpreted in accordance with the breadth to which they are fairly, legally and equitably entitled.

1. A bumper integrated cargo carrier, comprising:
a bumper assembly including a first receiver and a second receiver;
a first pivot arm displaceable between a first stowed position in said first receiver and a first deployed position projecting from said first receiver; and
a second pivot arm displaceable in an opposite direction from the first pivoting arm between a second stowed position in said second receiver and a second deployed position projecting from said second receiver.

2. The bumper integrated cargo carrier of claim 1, further including a first pivot connecting said first pivot arm to said bumper assembly and a second pivot connecting said second pivot arm to said bumper assembly.

3. The bumper integrated cargo carrier of claim 2, wherein said bumper assembly includes an outer face and said first pivot and said second pivot are inboard said outer face of said bumper assembly.

4. The bumper integrated cargo carrier of claim 3, wherein said first pivot arm includes a first face contoured to follow and be flush with said outer face when said first pivot arm is in said first stowed position in said first receiver.

5. The bumper integrated cargo carrier of claim 4, wherein said second pivot arm includes a second face contoured to follow and be flush with said outer face when said second pivot arm is in said second stowed position in said second receiver.

6. The bumper integrated cargo carrier of claim 5, wherein said first pivot arm includes a first set of loops.

7. The bumper integrated cargo carrier of claim 6, wherein said first pivot arm includes a first set of channels.

8. The bumper integrated cargo carrier of claim 7, wherein loops of said first set of loops alternate with channels of said first set of channels.

9. The bumper integrated cargo carrier of claim 8, wherein said second pivot arm includes a second set of loops.

10. The bumper integrated cargo carrier of claim 9, wherein said second pivot arm includes a second set of channels.

11. The bumper integrated cargo carrier of claim 10, wherein loops of said second set of loops alternate in the with channels of said second set of channels.

12. The bumper integrated cargo carrier of claim 11, further including a cargo net stretched between said first set of loops on said first pivot arm and said second set of loops on said second pivot arm.

13. The bumper integrated cargo carrier of claim 12, further including a set of cargo bars extending between said first set of channels on said first pivot arm and said second set of channels on said second pivot arm.

14. The bumper integrated cargo carrier of claim 13, wherein each cargo bar of said set of cargo bars includes an elongated channel.

15. A pivot arm for a cargo carrier, comprising:
an elongated body;
a first set of loops carried on said elongated body; and
a first set of channels carried on said elongated body, wherein loops of said first set of loops alternate with channels of said first set of channels along said elongated body.

16. (canceled)

17. The pivot arm of claim 15, including a receiver and a pivot pin secured in said receiver.

18. A method for carrying cargo, comprising:
pivoting a first pivot arm from a first stowed position into a first deployed position;
pivoting a second pivot arm from a second stowed position into a second deployed position; and
securing an article carrier between said first pivot arm and said second pivot arm.

19. The method of claim 18, including connecting a cargo net between a first set of loops provided on said first pivot arm and a second set of loops provided on said second pivot arm.

20. The method of claim 18, including connecting cargo bars between a first set of channels provided on said first pivot arm and a second set of channels provided on said second pivot arm.
